(19) United States
(12) Patent Application Publication
(10) Pub. No.: US 2022/0194408 A1
(43) Pub. Date: Jun. 23, 2022

(54) INFORMATION PROCESSING METHOD AND INFORMATION PROCESSING SYSTEM

(71) Applicant: Panasonic Intellectual Property Management Co., Ltd., Osaka (JP)

(72) Inventors: Motoshi ANABUKI, Hyogo (JP); Kazuma TAKEUCHI, Kyoto (JP); Shinji OHYAMA, Osaka (JP); Beier HU, Osaka (JP)

(21) Appl. No.: 17/691,711

(22) Filed: Mar. 10, 2022

Related U.S. Application Data
(63) Continuation of application No. PCT/JP2020/046256, filed on Dec. 11, 2020.

(30) Foreign Application Priority Data
Dec. 26, 2019 (JP) 2019-236880

(51) Int. Cl. B60W 50/14; B60W 60/00

(52) U.S. Cl. CPC B60W 50/14; B60W 2556/45; B60W 60/0015

(57) ABSTRACT

An information processing method is to be executed by a computer, and the information processing method includes obtaining a task related to traveling executed by a mobile body, first sensing data output from a first sensor that is provided in the mobile body and performs sensing of an outside of the mobile body, and a specification related to the traveling of the mobile body; calculating a sensing requirement based on the task and the specification; calculating a first sensing result based on the first sensing data output from the first sensor; determining whether to restrict execution of the task based on the sensing requirement and the first sensing result; and outputting an instruction for restricting the execution of the task to the mobile body in response to determining that the execution of the task is to be restricted.

### CROSS REFERENCE TO RELATED APPLICATIONS

This is a continuation application of PCT International Application No. PCT/JP2020/046256 filed on Dec. 11, 2020, designating the United States of America, which is based on and claims priority of Japanese Patent Application No. 2019-236880 filed on Dec. 26, 2019. The entire disclosures of the above-identified applications, including the specifications, drawings and claims are incorporated herein by reference in their entirety.

### FIELD

The present disclosure relates to an information processing method and an information processing system.

### BACKGROUND

For example, PTL 1 discloses a driving assistance device that receives, as an external map, an obstacle map from a peripheral body. The obstacle map is identified based on a braking distance corresponding to the moving speed of a mobile body, a braking time that takes for the mobile body to come to a stop, and a traveling path of the mobile body. The obstacle map indicates an obstacle or obstacles within a range in which the mobile body may collide with the obstacle or obstacles.

### CITATION LIST

### Patent Literature

PTL 1: Japanese Patent No. 6312944

### SUMMARY

### Technical Problem

The invention disclosed in PTL 1, however, does not necessarily ensure that the mobile body can safely execute a task related to the traveling (hereinafter, a traveling task). For example, depending on a specification related to the traveling of the mobile body (hereinafter, a traveling specification or a vehicle specification), the mobile body may not be able to travel safely even if the mobile body executes a traveling task in accordance with the external map.

Accordingly, the present disclosure is directed to providing an information processing method and an information processing system that each allow mobile bodies of various traveling specifications to safely execute traveling tasks.

### Solution to Problem

An information processing method according to one aspect of the present disclosure is an information processing method to be executed by a computer, and the information processing method includes: obtaining a task related to traveling executed by a mobile body, first sensing data output from a first sensor that is provided in the mobile body and performs sensing of an outside of the mobile body, and a specification related to the traveling of the mobile body; calculating a sensing requirement based on the task and the specification; calculating a first sensing result based on the first sensing data output from the first sensor; determining whether to restrict execution of the task based on the sensing requirement and the first sensing result; and outputting an instruction for restricting the execution of the task to the mobile body in response to determining that the execution of the task is to be restricted.

It is to be noted that some specific aspects of the above may be implemented in the form of a system, a method, an integrated circuit, a computer program, or a computer readable recording medium, such as a CD-ROM, or through any desired combination of a system, a method, an integrated circuit, a computer program, and a recording medium.

### Advantageous Effects

The information processing method and so on according to the present disclosure allow mobile bodies of various specifications to safely execute traveling tasks.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an information processing system according to an embodiment.

FIG. 2A illustrates an example of a traveling task of the information processing system according to the embodiment.

FIG. 2B illustrates an example of traveling plan information of the information processing system according to the embodiment.

FIG. 2C illustrates an example of vehicle specification information of the information processing system according to the embodiment.

FIG. 2D illustrates an example of traveling site information of the information processing system according to the embodiment.

FIG. 2E illustrates an example of safety requirement information of the information processing system according to the embodiment.

FIG. 2F illustrates an example of a required sensing region of the information processing system according to the embodiment.

FIG. 3 is a flowchart illustrating an operation of the information processing system according to the embodiment.

FIG. 4A is a flowchart illustrating a detailed operation of the information processing system according to the embodiment.

FIG. 4B illustrates an example of an actual sensing region of the information processing system according to the embodiment.

FIG. 5 is a flowchart illustrating a process of calculating a required sensing distance.

FIG. 6 illustrates an example of a required sensing region and a required sensing distance.

FIG. 7 is a flowchart illustrating a process of searching a target region lane.

FIG. 8A is a flowchart illustrating a process of calculating an actual sensing region.

FIG. 8B is a flowchart illustrating a process of calculating an actual sensing distance for each sensor.

FIG. 9 illustrates an example of a relationship between a first sensing region and a second sensing region.

FIG. 10 illustrates an example of a relationship between a required sensing region and an actual sensing region.

FIG. 11 is a schematic diagram illustrating an information processing system according to a variation.

FIG. 12A illustrates an example of a traveling task of an information processing system according to Variation 5.

FIG. 12B illustrates an example of traveling plan information of the information processing system according to Variation 5.

FIG. 12C illustrates an example of robot specification information of the information processing system according to Variation 5.

FIG. 12D illustrates an example of traveling site information of the information processing system according to Variation 5.

FIG. 12E illustrates an example of safety requirement information of the information processing system according to Variation 5.

FIG. 12F illustrates an example of a required sensing region of the information processing system according to Variation 5.

FIG. 13 illustrates an example of a required sensing region and a required sensing distance.

### DESCRIPTION OF EMBODIMENTS

With the advancement in the automatic driving technology in recent years, the transit service provided by automatic driving vehicles is expected to become widely available. For example, an automatic driving vehicle is designed such that the automatic driving vehicle is optimized to be able to travel in a specific traveling situation (in a specific area, environment, time range, or the like). Meanwhile, there may be a case where an automatic driving vehicle optimized for a specific traveling situation is used in a different traveling situation. However, an automatic driving vehicle may not necessarily be able to determine on its own whether the automatic driving vehicle is suitable for a given traveling situation. Therefore, if an automatic driving vehicle travels in a traveling situation for which this automatic driving vehicle is not optimized, there is a possibility that the combination of the traveling specification and the sensor specification of the automatic driving vehicle is not appropriate for that traveling situation. In other words, there is a possibility that the safety of the automatic driving vehicle cannot be ensured as its sensing performance lags behind its traveling performance. For example, although the driving assistance is provided with the use of an external map according to PTL 1, if the traveling specification is not appropriate for a given traveling situation, the safety of the traveling of the mobile body cannot necessarily be ensured even with the use of the external map.

In this respect, an information processing method according to one aspect of the present disclosure is an information processing method to be executed by a computer, and the information processing method includes: obtaining a task related to traveling executed by a mobile body, first sensing data output from a first sensor that is provided in the mobile body and performs sensing of an outside of the mobile body, and a specification related to the traveling of the mobile body; calculating a sensing requirement based on the task and the specification; calculating a first sensing result based on the first sensing data output from the first sensor; determining whether to restrict execution of the task based on the sensing requirement and the first sensing result; and outputting an instruction for restricting the execution of the task to the mobile body in response to determining that the execution of the task is to be restricted.

According to the above, when the mobile body travels, the execution of a traveling task can be restricted depending on the sensing requirement required from the traveling specification of the mobile body and the sensing result. In other words, the execution of the traveling task can be restricted when the traveling specification and the sensor specification are not appropriate for the traveling situation. Accordingly, this configuration allows mobile bodies of various specifications to safely execute traveling tasks. For example, as will be described later, in a case where the traveling specification and the sensor specification of a mobile body are not appropriate for a given traveling situation and the execution of the traveling task cannot be completed or the traveling task cannot be executed, that is, in a case where the mobile body cannot travel, the execution of this traveling task is stopped. This makes it possible to suppress an occurrence or an accident or an incident associated with the execution of this traveling task. Moreover, for example, in a case where the traveling specification and the sensor specification of a mobile body are not appropriate for a given traveling situation and the traveling task cannot be executed safely, that is, in a case where the mobile body cannot travel safely, the content of the execution of this traveling task is changed. With this configuration, even if the mobile body does not completely satisfy the safety condition for the traveling, the mobile body can continue to travel safely by executing a traveling task whose content has been restricted, in place of the original traveling task.

An information processing system according to another aspect of the present disclosure includes a first obtainer, a second obtainer, a third obtainer, a first calculator, a second calculator, a determiner, and an outputter. The first obtainer obtains a task related to traveling executed by a mobile body. The second obtainer obtains first sensing data output from a first sensor that is provided in the mobile body and performs sensing of an outside of the mobile body. The third obtainer obtains a specification related to the traveling of the mobile body. The first calculator calculates a sensing requirement based on the task and the specification. The second calculator calculates a first sensing result based on the first sensing data output from the first sensor. The determiner determines whether to restrict execution of the task based on the sensing requirement and the first sensing result. The outputter outputs an instruction for restricting the execution of the task to the mobile body when the execution of the task is determined to be restricted.

With this information processing system as well, workings and advantageous effects similar to those described above can be obtained.

In the information processing method according to another aspect of the present disclosure, the sensing requirement includes a required sensing region that is a region that requires sensing, and the first sensing result includes a first sensing region calculated based on the first sensing data. Moreover, the determining includes determining whether to restrict the execution of the task based on the required sensing region and the first sensing region.

In order to prevent an accident or an incident at a moving destination, the mobile body needs to be capable of performing sensing of the moving destination and its surrounding area. For example, the mobile body needs to be capable of performing sensing of a region to serve as a moving destination and a region where an object moving toward the moving destination may be present. In this respect, the present configuration can restrict the execution of a traveling task based on a result of comparing the required sensing region and the sensing region of the mobile body. For example, the execution of the traveling task can be restricted if the mobile body is unable to perform sensing of the required sensing region. Accordingly, the present configuration makes it possible to execute the traveling task safely.

In the information processing method according to another aspect of the present disclosure, the determining includes determining whether to restrict the execution of the task based on an overlap between the required sensing region and the first sensing region.

An overlap between the required sensing region and the first sensing region affects the safety of executing the traveling task. Therefore, restricting the execution of the traveling task based on this overlap allows the mobile body to execute the traveling task safely. In other words, the mobile body can travel more safely.

In the information processing method according to another aspect of the present disclosure, the determining includes determining whether to restrict the execution of the task based on a degree of the overlap between the required sensing region and the first sensing region.

The degree of the overlap between the required sensing region and the first sensing region is related to the degree of safety of executing the traveling task. Therefore, restricting the execution of the traveling task based on this degree of the overlap allows the mobile body to execute the traveling task safely. In other words, the mobile body can travel more safely.

In the information processing method according to another aspect of the present disclosure, the determining includes determining whether to restrict the execution of the task based on a region in which the required sensing region and the first sensing region do not overlap each other.

The safety of executing the traveling task may not decrease that much even if there is a region in which the required sensing region and the first sensing region do not overlap each other. For example, the safety risk is low even if the sensing is insufficient in a region where the importance concerning the safety of the traveling is low, such as a region behind the mobile body or a region in the direction opposite to the traveling direction of the mobile body. Conversely, a region in which the required sensing region and the first sensing region do not overlap each other may lower the safety of executing the traveling task. For example, the safety risk is high if the sensing is insufficient in a region where the importance concerning the safety of the traveling is high, such as a region close to the mobile body or a region in the traveling direction of the mobile body. Therefore, restricting the execution of the traveling task based on the region in which the required sensing region and the first sensing region do not overlap each other (e.g., based on the importance of the region) makes it possible to increase the efficiency of the traveling while allowing the mobile body to travel safely. In the information processing method according to another aspect of the present disclosure, the restricting prohibits the execution of the task.

According to the above, when the traveling task cannot be executed safely, the execution of the traveling task may be stopped. Thus, an occurrence of an accident or an incident caused by the traveling of the mobile body can be suppressed more reliably.

In the information processing method according to another aspect of the present disclosure, the restricting changes content of the task to be executed.

According to the above, the mobile body can continue to execute the traveling task safely without stopping the traveling task. Accordingly, the efficiency of the traveling can be maintained or a decrease in the efficiency of the traveling can be suppressed while ensuring the safety of the mobile body. For example, the traveling task can be executed safely by reducing the speed, changing the intersection to make a right turn, changing the position to stop the mobile body, or delaying the timing at which the mobile body starts moving.

In the information processing method according to another aspect of the present disclosure, content of a change in the task is determined based on an overlap between the required sensing region and the first sensing region.

As described above, an overlap between the required sensing region and the first sensing region affects the safety of executing the traveling task. Therefore, as the content of the traveling task is changed in accordance with the overlap, the traveling task can be changed to a traveling task with higher safety content.

The information processing method according to another aspect of the present disclosure further includes obtaining second sensing data output from a second sensor provided on a path of travel of the mobile body and calculating a second sensing result based on the second sensing data. The determining includes determining whether to restrict the execution of the task based further on the second sensing result.

As the second sensing data is used in addition to the first sensing data in the sensing, the sensing region can be broadened even if the sensing performance of the first sensor of the mobile body is low. This broadening of the sensing region that overlaps the required sensing region makes it more likely that the traveling task is executed safely. In other words, the mobile body is likely to be able to travel more safely.

The information processing method according to another aspect of the present disclosure further includes adding the mobile body to a target to be monitored or raising a monitoring priority of the mobile body in response to determining that the execution of the task is to be restricted.

A mobile body of which the execution of the traveling task is restricted is more likely to cause an accident or an incident than other mobile bodies. Therefore, the mobile body of which the execution of the traveling task is restricted may be, for example, subjected to monitoring or assigned a higher monitoring priority, and thus an occurrence of an accident or an incident can be suppressed. Moreover, even if an accident or an incident occurs, the monitorer can respond to the accident or the incident promptly.

The information processing method according to another aspect of the present disclosure further includes notifying a manager or an occupant of the mobile body that the execution of the task is to be restricted, in response to determining that the execution of the task is to be restricted.

According to the above, the manager or the occupant can find that the execution of the traveling task of the mobile body has been restricted. For example, in a case where the manager is the monitorer, the above aspect makes it possible to suppress a situation in which the monitorer fails to notice the mobile body that has a higher likelihood of causing an accident or an incident than other mobile bodies. In addition, since it suffices that this mobile body be monitored preferentially, the burden on the monitorer monitoring mobile bodies can be reduced. Furthermore, any discomfort that an occupant feels about the mobile body that the occupant is riding can be reduced.

In the information processing method according to another aspect of the present disclosure, the sensing requirement includes a required sensing target that is a target that requires sensing, and the first sensing result includes a first sensing target calculated based on the first sensing data. Moreover, the determining includes determining whether to restrict the execution of the task based on the required sensing target and the first sensing target.

In order to prevent an accident or an incident at a moving destination, the mobile body needs to be capable of performing sensing of a target that can cause the accident or the incident. For example, the mobile body needs to be capable of performing sensing of an obstacle located at the moving destination, the road surface condition of the moving destination, or the like. In this respect, the present configuration can restrict the execution of a traveling task based on a result of comparing the required sensing target and the target sensed by the mobile body. Accordingly, the present configuration makes it possible to execute the traveling task safely.

In the information processing method according to another aspect of the present disclosure, the determining includes determining whether to restrict the execution of the task based on a degree of sufficiency of or a degree of match between the required sensing target and the first sensing target.

The degree of match between the required sensing target and the first sensing target, that is, whether the target to be subjected to the sensing is being subjected to the sensing as well as the precision or the accuracy of this sensing affects the safety of executing the traveling task. Therefore, restricting the execution of the traveling task based on the degree of match between the sensing targets allows the mobile body to execute the traveling task safely. For example, the execution of the traveling task can be restricted if the mobile body is unable to perform sensing of the required sensing target.

In the information processing method according to another aspect of the present disclosure, the sensing requirement includes required sensing performance that is a target that requires sensing, and the first sensing result includes first sensing performance calculated based on the first sensing data. Moreover, the determining includes determining whether to restrict the execution of the task based on the required sensing performance and the first sensing performance.

In order to prevent an accident or an incident at a moving destination, the mobile body needs to have sufficient sensing performance. For example, the precision, the accuracy, the resolution, the processing cycle, or the like of the sensing needs to be sufficient. In this respect, the present configuration can restrict the execution of a traveling task based on a result of comparing the required sensing performance and the sensing performance of the mobile body. Accordingly, the present configuration makes it possible to execute the traveling task safely.

In the information processing method according to another aspect of the present disclosure, the determining includes determining whether to restrict the execution of the task based on whether the first sensing performance is higher than the required sensing performance.

In this manner, restricting the execution of the traveling task based on the superiority of the sensing performance allows the mobile body to execute the traveling task safely. For example, the execution of the traveling task can be restricted if the sensing performance of the mobile body is lower than the required sensing performance.

The embodiment described hereinafter merely illustrates a specific example of the present disclosure. The numerical values, the shapes, the materials, the constituent elements, the arrangement positions of the constituent elements, and so on illustrated in the following embodiment are examples and are not intended to limit the present disclosure. In addition, among the constituent elements described in the following embodiment, any constituent element that is not described in the independent claims is to be construed as an optional constituent element. Furthermore, the respective contents of all the embodiments can be combined with each other.

Hereinafter, an information processing method and an information processing system according to one aspect of the present disclosure will be described in concrete terms with reference to the drawings.

### Embodiment

### [Configuration: Information Processing System 1]

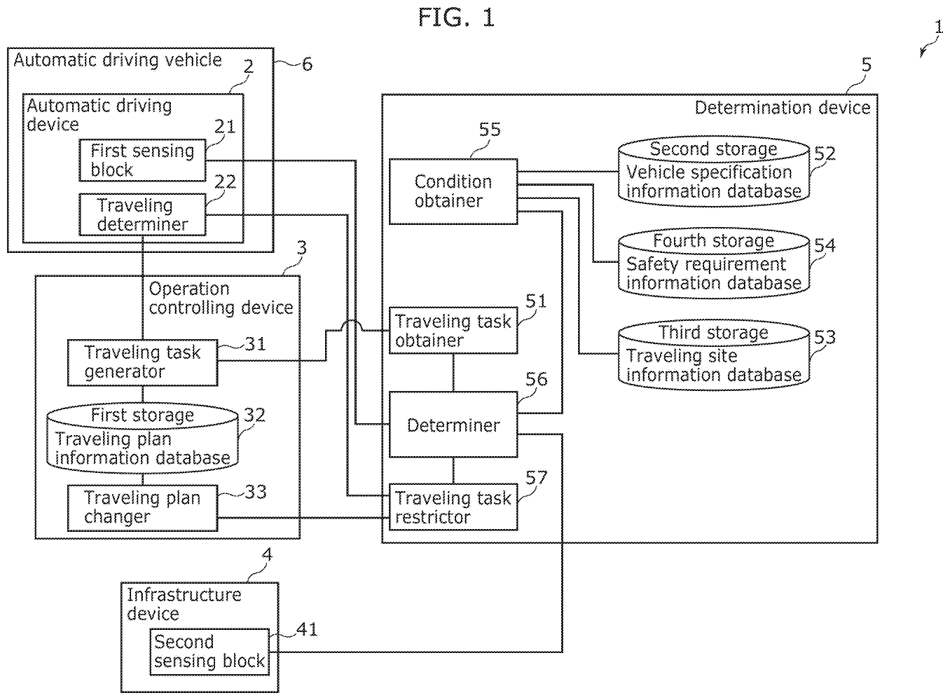

FIG. 1 is a block diagram illustrating information processing system 1 according to an embodiment.

As illustrated in FIG. 1, information processing system 1 includes automatic driving device 2, operation controlling device 3, infrastructure device 4, and determination device 5. In this example, only automatic driving device 2 may be provided in a mobile body, or automatic driving device 2 and operation controlling device 3 may be provided in a mobile body.

### [Automatic Driving Device 2]

Automatic driving device 2 is provided in a mobile body and performs sensing of the surroundings of the mobile body. Automatic driving device 2 controls the traveling of the mobile body based on the result of the sensing. The mobile body is, for example but not limited to, a vehicle, an aircraft, or a ship. According to the present embodiment described below, an assumption is that the mobile body is automatic driving vehicle 6.

Automatic driving device 2 includes first sensing block 21 and traveling determiner 22.

First sensing block 21 serves as a first sensor and outputs first sensing data to determination device 5.

First sensing block 21 is, for example, a sensor or a sensor module, such as a laser imaging detection and ranging (Lidar) or an imaging device, and performs sensing of the outside of automatic driving vehicle 6. First sensing block 21 generates first sensing data indicating the result of the sensing. The first sensing data is, for example, point cloud information or an image.

Traveling determiner 22 obtains a task related to the traveling (hereinafter, this task may also be referred to as a traveling task) that is generated by traveling task generator 31 and to be executed by automatic driving vehicle 6. Traveling determiner 22 also obtains a traveling task permission output by traveling task restrictor 57. Based on the obtained traveling task and traveling task permission, traveling determiner 22 determines whether to execute the traveling task or executes the traveling task determined to be executed, for example. When traveling determiner 22 is to execute a traveling task, traveling determiner 22 outputs a traveling instruction corresponding to the traveling task to automatic driving vehicle 6.

### [Operation Controlling Device 3]

Operation controlling device 3 includes traveling task generator 31, first storage 32, and traveling plan changer 33.

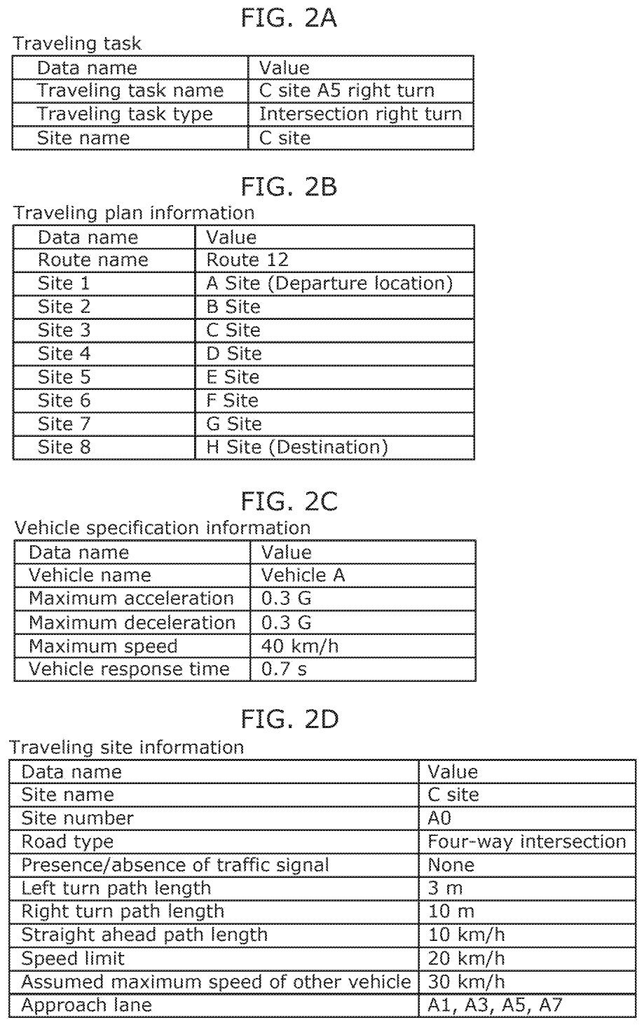

Traveling task generator 31 generates a traveling task based on traveling plan information obtained from first storage 32. In this example, a traveling task is a task associated with higher-level traveling control that is more abstract than lower-level traveling control of controlling an actuator. Specifically, the lower-level traveling control is the controlling of the speed, the acceleration, the deceleration, the steering angle, and so on, whereas the higher-level traveling control is the controlling of automatic driving vehicle 6 such that automatic driving vehicle 6, for example, moves straight ahead, turns right, turns left, avoids an obstacle, is parked, changes lanes, merges with traffic, starts traveling, or stops, for example. For example, as illustrated in FIG. 2A, a traveling task includes the traveling task name, the traveling task type, and the site name. FIG. 2A illustrates an example of a traveling task of information processing system 1 according to the embodiment.

As illustrated in FIG. 2B, traveling plan information includes the route and the site or sites along the route where the traveling task is executed. The sites include, for example, the departure location, the destination, a right turn site, a left turn site, or a stopping site. FIG. 2B illustrates an example of traveling plan information of information processing system 1 according to the embodiment.

Traveling task generator 31 outputs a generated traveling task to determination device 5.

First storage 32 stores a traveling plan information database indicating a traveling plan of automatic driving vehicle 6. First storage 32 outputs traveling plan information in response to a request from traveling task generator 31. Moreover, when traveling plan changer 33 has made a change to traveling plan information, first storage 32 updates the traveling plan information so as to reflect the change.

In a case where it becomes necessary to make a change to traveling plan information based on an instruction for restricting the execution of a traveling task (hereinafter, a restriction), traveling plan changer 33 makes a change to the traveling plan information stored in first storage 32 to update the traveling plan information. Moreover, in a case where traveling plan changer 33 has obtained a traveling task permission output from traveling task restrictor 57 as well, traveling plan changer 33 may update the traveling plan information stored in first storage 32 so as to indicate that the traveling task has been permitted. In this example, when a change is made to traveling plan information, the user may manually change the traveling plan information to a desired plan. Herein, a restriction is for prohibiting the execution of a traveling or for changing of the content of a traveling task to be executed. For example, the prohibiting of the execution of a traveling task is the prohibiting of the traveling, the prohibiting of making a right turn or a left turn, the prohibiting of stopping, or the like. Moreover, for example, the changing of the content of a traveling task to be executed is the changing of the speed or the acceleration, the changing of traveling lanes, or the like.

Specifically, even if the traveling task indicates a right turn, if the obtained restriction indicates that the right turn is prohibited, traveling plan changer 33 makes a change to the traveling plan by, for example but not limited to, deleting this traveling task and adding a new traveling task.

### [Infrastructure Device 4]

Infrastructure device 4 is set on infrastructure, such as a road or a traffic signal. Infrastructure device 4 includes second sensing block 41.

Second sensing block 41 is a sensor provided along a traveling path of automatic driving vehicle 6. Second sensing block 41 performs sensing of the surroundings of its host vehicle and generates second sensing data. Second sensing block 41 outputs the generated second sensing data to determination device 5. Second sensing block 41 may be an example of a second sensor.

### [Determination Device 5]

Determination device 5 includes traveling task obtainer 51, second storage 52, third storage 53, fourth storage 54, condition obtainer 55, determiner 56, and traveling task restrictor 57.

Traveling task obtainer 51 obtains a traveling task output by traveling task generator 31 of operation controlling device 3. Traveling task generator 51 outputs the obtained traveling task to determiner 56. Traveling task obtainer 51 is an example of a first obtainer.

Second storage 52 stores a database of vehicle specification information indicating the vehicle specification of automatic driving vehicle 6 (hereinafter, a vehicle specification information database). Second storage 52 outputs vehicle specification information in response to a request from condition obtainer 55. The vehicle specification is a specification related to the traveling of automatic driving vehicle 6. Specifically, as illustrated in FIG. 2C, the vehicle specification information includes, for example but not limited to, the vehicle name, the maximum acceleration, the maximum deceleration, the maximum speed, and the vehicle response time. The vehicle response time is the time in which, after receiving an instruction, automatic driving vehicle 6 actually starts executing or completes the operation corresponding to the instruction. For example, in a case where automatic driving vehicle 6 is given an instruction to stop, the vehicle response time is the time it takes for automatic driving vehicle 6 to start braking. The vehicle specification may further include, for example but not limited to, the size of automatic driving vehicle 6, the weight of automatic driving vehicle 6, the minimum turning radius, the vehicle response speed, the obstacle detecting performance, the self-position estimation accuracy, the path following accuracy, the type of a sensor or sensors provided in automatic driving vehicle 6, and an object or objects that the sensor or sensors can detect. FIG. 2C illustrates an example of vehicle specification information of information processing system 1 according to the embodiment.

Third storage 53 stores a database of traveling site information indicating various pieces of information on the traveling sites expressed by the map (hereinafter, a traveling site information database). Third storage 53 outputs traveling site information in response to a request from condition obtainer 55. The traveling site information is map information of the traveling path and traffic environmental information. Specifically, as illustrated in FIG. 2D, the traveling site information includes map information, such as the site name, the site number assigned to the site name, or the road type, as well as the traffic environmental information, such as the presence or absence of a traffic signal, the left turn path length, the right turn path length, the straight ahead path length, the speed limit, the assumed maximum speed of other vehicles, and the approach lanes. FIG. 2D illustrates an example of traveling site information of information processing system 1 according to the embodiment.

Fourth storage 54 stores a database of safety requirement information indicating the safety requirement with respect to a traveling task (hereinafter, a safety requirement information database). Fourth storage 54 outputs safety requirement information in response to a request from condition obtainer 55. The safety requirement information indicates requirements set in advance by a service provider or the like in order for automatic driving vehicle 6 to travel safely with respect to a given traveling task. In other words, the safety requirement information relates to the execution condition of the traveling task. Specifically, as illustrated in FIG. 2E, the safety requirement information includes, for example but not limited to, the traveling task name, the target region type, the road type, the required sensing range within the intersection, the required sensing range of an approach lane or approach lanes, and the required sensing range calculating input. Among the above, the target region type, the required sensing range within the intersection, and the required sensing range of the approach lane or approach lanes are the safety requirements related to the sensing requirements. FIG. 2E illustrates an example of safety requirement information of information processing system 1 according to the embodiment. In this example, the safety requirement information may further include information other than the information related to the sensing requirements described above. For example, the safety requirement information includes the safety requirements related to the traveling environment, such as an obstacle, the blind zone region, the weather, the road surface condition, and the illuminance. The safety requirements related to the traveling environment are used in the calculation of the traveling environment requirement.

The target region type indicates the type of the region in which there is a possibility that automatic driving vehicle 6 collides with another object. Specifically, in the example illustrated in FIG. 2E, the target region type indicates, as the type of the region described above, the inside of the intersection and the approach lane or approach lanes other than the lane in which automatic driving vehicle 6 is located.

The required sensing range inside the intersection is the required sensing range of the region of which the type is the inside of an intersection. For example, since there is a possibility that automatic driving vehicle 6 collides with another mobile body at any portion inside an intersection, the required sensing range of the inside of the intersection is set to the entire region.

The required sensing range of the approach lane is the required sensing range of a region of which the type is an approach lane. For example, since the possibility of a collision is low in a region far away from an approach lane, the required sensing range of the approach lane is set to a region spanning from the intersection to the required sensing distance.

In this example, the required sensing range calculating input is information that is input to calculate the required sensing distance described above. As such, the required sensing range calculating input may also be regarded as information associated with the required sensing range of the target region. The required sensing range calculating input is, for example but not limited to, the maximum speed of automatic driving vehicle 6, the speed limit, the maximum acceleration, the vehicle response time, the right turn path length, and the assumed maximum speed of other vehicles.

Condition obtainer 55 obtains vehicle specification information from second storage 52 and traveling site information from third storage 53. Moreover, condition obtainer 55 obtains a traveling task from traveling task obtainer 51 via determiner 56. Condition obtainer 55 is an example of a first calculator and is also an example of a third obtainer. Condition obtainer 55 further obtains safety requirement information from fourth storage 54.

Condition obtainer 55 calculates the execution condition of a traveling task. The execution condition of a traveling task is a condition for determining whether the traveling task can be executed normally, that is, a condition for determining whether the sensing is sufficient for executing the traveling task. The execution condition of a traveling task is the execution condition of a traveling task corresponding to at least one of automatic driving vehicle 6 or the traveling site. For example, the execution condition of a traveling task is a condition for determining whether it is possible to execute a traveling task of automatic driving vehicle 6, such as traveling straight ahead, turning right, turning left, avoiding an obstacle, being parked, changing lanes, merging with traffic, starting to travel, or stopping. Therefore, the execution condition includes the sensing requirement as one of the elements. Moreover, the execution condition includes the traveling environment requirement as another one of the elements. Examples of an element of the traveling environment requirement include an obstacle, the blind zone region, the weather, the road surface condition, and the illuminance. The execution condition is calculated based on the safety requirement information.

Condition obtainer 55 calculates and obtains the sensing requirement based on the vehicle specification information and the traveling task obtained via determiner 56. Specifically, condition obtainer 55 calculates the required sensing region that is the region that requires sensing based on the vehicle specification information and the traveling task. In other words, based on the traveling site information matching the site indicated by the traveling task and the vehicle specification information, condition obtainer 55 calculates and obtains the required sensing region necessary for automatic driving vehicle 6 with the obtained vehicle specifications to execute the traveling task. To be more specific, condition obtainer 55 calculates the required sensing region based on the vehicle specification information, the traveling task, and the safety requirement information. For example, condition obtainer 55 obtains, from the traveling task, the traveling site information of the corresponding traveling site and the safety requirement information. Condition obtainer 55 obtains, from the obtained safety requirement information, the target region type, the required sensing range of each target region type, and the required sensing range calculating input. Condition obtainer 55 obtains information indicated by the obtained required sensing range calculating input from the vehicle specification information and the traveling site information. Condition obtainer 55 calculates the required sensing range for each target region within the site by use of the obtained information. The sensing region of the target region calculated in this manner is the required sensing region.

As illustrated in FIG. 2F, the required sensing region includes the vehicle name, the traveling task name, the target region ID, and the required sensing range for each region type. The required sensing range is, for example, the entire region or the required sensing distance in the target region. In the example illustrated in FIG. 2F, the entire region is set for target region A0, and the required sensing distance of 43 meters is set for each of target regions A1, A3, and A7. FIG. 2F illustrates an example of required sensing region of information processing system 1 according to the embodiment.

Condition obtainer 55 obtains the execution condition including the required sensing region mainly before automatic driving vehicle 6 starts traveling. Alternatively, condition obtainer 55 may obtain the execution condition while automatic driving vehicle 6 is traveling.

Condition obtainer 55 outputs the obtained execution condition to determiner 56.

Determiner 56 obtains the first sensing data from first sensing block 21, the second sensing data from second sensing block 41, and the execution condition including the sensing requirement from condition obtainer 55. Moreover, determiner 56 obtains the traveling task from traveling task obtainer 51.

Determiner 56 calculates a first sensing result based on the first sensing data. The first sensing result is a first sensing region indicating the region where first sensing block 21 has performed the sensing. Moreover, determiner 56 calculates a second sensing result based on the second sensing data. The second sensing result is a second sensing region indicating the region where second sensing block 41 has performed the sensing. In this example, the first sensing result and the second sensing result may each include other pieces of information. For example, the first sensing result and the second sensing result may each include, for example but not limited to, the presence or absence of an obstacle, the type of an obstacle, the position of an obstacle, the size of an obstacle, the blind zone region caused by an obstacle, the weather, the road surface condition, and the illuminance. The first sensing region and the second sensing region are each an actual sensing region.

Determiner 56 determines whether to restrict the execution of the traveling task based on the first sensing result and the sensing requirement. Specifically, determiner 56 determines whether to restrict the execution of the traveling task by automatic driving vehicle 6 based on the first sensing region and the required sensing region of the execution condition. In other words, determiner 56 determines whether automatic driving vehicle 6 can properly determine whether automatic driving vehicle 6 may execute the traveling task. That automatic driving vehicle 6 can properly determine whether to execute a traveling task means that the first sensing result is sufficient, that is, the first sensing result satisfies the sensing requirement. For example, determiner 56 determines whether to restrict the execution of the traveling task based on an overlap between the required sensing region and the first sensing region. Specifically, determiner 56 makes this determination based on the degree of overlap between the required sensing region and the first sensing region. For example, determiner 56 refrains from restricting the execution of the traveling task in a case where the entirety or no less than a predetermined proportion of the required sensing region overlaps the first sensing region. In contrast, determiner 56 restricts the execution of the traveling task in a case where none or less than the predetermined proportion of the required sensing region overlaps the first sensing region.

Moreover, determiner 56 determines whether to restrict the execution of the traveling task based also on the second sensing region. For example, determiner 56 determines whether to restrict the execution of the traveling task based on an overlap between the required sensing region and a combined sensing region where the first sensing region and the second sensing region are combined.

In this example, determiner 56 may make the determination based on the region where the required sensing region and the first sensing region do not overlap each other. Specifically, determiner 56 determines whether the portion of the required sensing region where the required sensing region does not overlap the first sensing region is a region that affects the traveling safety of automatic driving vehicle 6. The region that affects the safety is, for example but not limited to, a region close to automatic driving vehicle 6, a region in the traveling direction of automatic driving vehicle 6, a region on the path along which automatic driving vehicle 6 is expected to travel, a sidewalk, and a region where a traffic signal is located. If the region that affects the traveling safety is this non-overlapping portion, determiner 56 restricts the execution of the traveling task.

Moreover, determiner 56 determines whether to restrict the execution of the traveling task based on other requirements of the execution condition. Specifically, determiner 56 determines whether to restrict the execution of the traveling task based on the traveling environment requirement and the first sensing data. For example, in a case where there is fog on the route or the road surface on the route is frozen, determiner 56 determines to restrict the execution of the traveling task. Moreover, in a case where the number of pedestrians at a predetermined site on the route is no less than a threshold or there has been an accident at the predetermined site on the route, determiner 56 determines to restrict the execution of the traveling task. Moreover, in a case where an animal has entered the route, determiner 56 determines to restrict the execution of the traveling task. Moreover, in a case where the communication condition between a monitorer terminal for monitoring automatic driving vehicle 6 and automatic driving vehicle 6 is bad, determiner 56 determines to restrict the execution of the traveling task.

Determiner 56 outputs the result of the determination to traveling task restrictor 57.

Upon obtaining the result of the determination from determiner 56, traveling task restrictor 57 restricts the execution of the traveling task in accordance with the result of the determination. Specifically, traveling task restrictor 57 generates a restriction, or an instruction for restricting the execution of the traveling task, in accordance with the result of the determination that determiner 56 has made on the sensing requirement. Specifically, traveling task restrictor 57 generates, as a restriction, the prohibition of the execution of the traveling task in accordance with the result of the determination that determiner 56 has made on the required sensing region. For example, in a case where the traveling task is to make a right turn, determiner 56 determines to restrict the execution of the traveling task if the portion of the required sensing region that corresponds to the direction of the right turn does not overlap the first sensing region. Therefore, traveling task restrictor 57 generates a restriction indicating the prohibition of making a right turn. Moreover, as a restriction, traveling task restrictor 57 determines the content of a change to be made to the traveling task in accordance with the result of the determination that determiner 56 has made on the required sensing region. Specifically, traveling task restrictor 57 determines the content of a change to be made to the traveling task based on an overlap between the first sensing region and the required sensing region (e.g., the presence or absence of the overlap, the degree of the overlap, or the like). For example, in a case where the traveling task is to travel straight ahead, determiner 56 determines to restrict the execution of the traveling task if the overlap between the first sensing region and the portion of the required sensing region that corresponds to the traveling direction is in less than a predetermined proportion. Therefore, traveling task restrictor 57 generates a restriction indicating the speed that makes the required sensing region and the first sensing region overlap by no less than a predetermined proportion (in other words, the speed limit).

Moreover, traveling task restrictor 57 generates a restriction in accordance with the result of the determination that determiner 56 has made on other requirements. Specifically, traveling task restrictor 57 generates a restriction in accordance with the result of the determination on the traveling environment requirement. For example, in a case where there is fog on the route or the road surface on the route is frozen, traveling task restrictor 57 generates a restriction for reducing the traveling speed. Moreover, in a case where the number of pedestrians at a predetermined site on the route is no less than a threshold or there has been an accident at the predetermined site on the route, traveling task restrictor 57 generates a restriction for prohibiting entry into the predetermined site. Moreover, in a case where an animal has entered the route, traveling task restrictor 57 generates a restriction for prohibiting access to this route or for changing the route. Moreover, in a case where the communication condition between a monitorer terminal for monitoring automatic driving vehicle 6 and automatic driving vehicle 6 is bad or an emergency vehicle is approaching, traveling task restrictor 57 generates a restriction for stopping the traveling.

In this example, the restriction on the traveling task may be generated based on an operation of a manager. For example, the manager selects a restriction, and traveling task restrictor 57 generates the restriction based on the result of the selection. Traveling task obtainer 57 is an example of an outputter. The manager is, for example but not limited to, a manager of information processing system 1 or one or more devices of information processing system 1, an owner of automatic driving vehicle 6, or a person who monitors automatic driving vehicle 6.

Traveling task restrictor 57 outputs the generated restriction to traveling determiner 22 and traveling plan changer 33. Moreover, traveling task restrictor 57 outputs, to traveling determiner 22, a traveling task permission indicating that the execution of the traveling task determined not to be restricted is permitted. In this example, traveling task restrictor 57 may output the traveling task permission to traveling plan changer 33.

### [Operation]

A process of information processing system 1 configured as described above will be described.

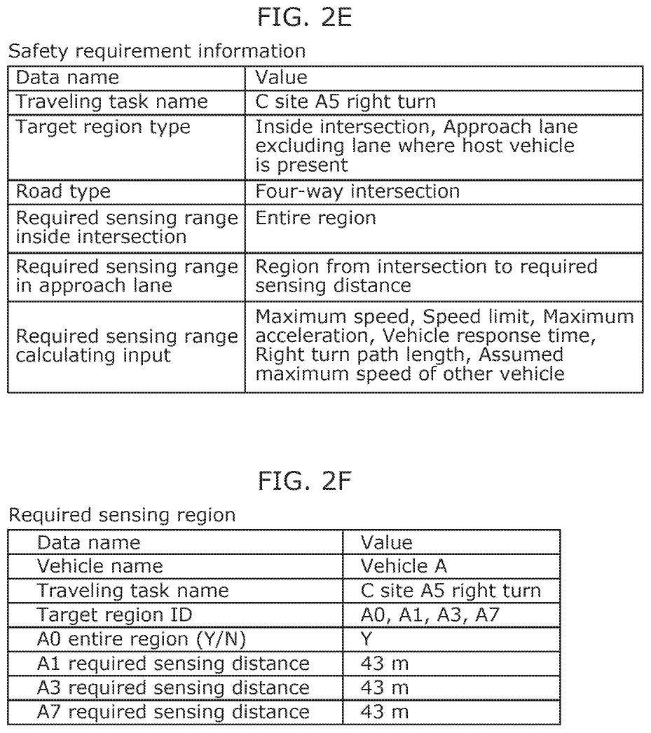

FIG. 3 is a flowchart illustrating a process of information processing system 1 according to the embodiment. With reference to FIG. 3, the general overview of the process of information processing system 1 will be described.

As illustrated in FIG. 3, before automatic driving vehicle 6 starts traveling, condition obtainer 55 calculates and obtains the execution condition of the traveling task at each traveling site of automatic driving vehicle 6 based on the vehicle specification information and the traveling site information (S11). The process of step S11 may be executed before automatic driving vehicle 6 starts traveling.

Next, traveling task obtainer 51 obtains a traveling task output from traveling task generator 31 (S12).

Next, determiner 56 obtains the first sensing data from first sensing block 21, the second sensing data from second sensing block 41, the execution condition from condition obtainer 55, and the traveling task from traveling task obtainer 51. Based on the obtained information, determiner 56 determines whether automatic driving vehicle 6 can properly make a determination on the execution of the traveling task (S13). In other words, based on the obtained information, determiner 56 determines whether to restrict the execution of the traveling task.

Next, if determiner 56 has determined not to restrict the execution of the traveling task (YES at S13), determiner 56 outputs a traveling task permission to traveling determiner 22 (S17). In response to obtaining the traveling task permission, traveling determiner 22 executes the traveling task indicated by the traveling task permission. With this process, automatic driving vehicle 6 is subjected to traveling control corresponding to the traveling task.

Next, traveling determiner 22 determines whether to end the traveling (S18). In other words, traveling determiner 22 determines whether automatic driving vehicle 6 has arrived at the destination.

If traveling determiner 22 has determined to end the traveling (YES at S18), traveling determiner 22 ends the traveling of automatic driving vehicle 6. In addition, information processing system 1 terminates the process.

Meanwhile, if traveling determiner 22 has determined not to end the traveling (NO at S18), the process returns to step S12.

If determiner 56 has determined to restrict the execution of the traveling task (NO at S13), traveling task restrictor 57 generates a restriction for the traveling task whose execution has been determined to be restricted and outputs the generated restriction to traveling plan changer 33 and traveling determiner 22 (S14).

Based on the restriction, traveling plan changer 33 makes a change to the traveling plan information of the traveling task stored in first storage 32 (S15). In other words, traveling plan changer 33 makes a change to the traveling plan by deleting the traveling site related to the restriction from the traveling plan or making a change to the traveling site related to the restriction.

Next, based on the restriction, traveling determiner 22 determines whether automatic driving vehicle 6 can continue with the traveling (S16). Specifically, based on the restriction, traveling determiner 22 suspends the execution of the traveling task or makes a change to the content of the traveling task to be executed. After suspending the execution of the traveling task or making a change to the content of the traveling task to be executed, traveling determiner 22 determines whether automatic driving vehicle 6 can continue with the traveling.

If traveling determiner 22 has determined that automatic driving vehicle 6 cannot continue with the traveling (NO at S16), traveling determiner 22 ends the traveling of automatic driving vehicle 6. In addition, information processing system 1 terminates the process.

If traveling determiner 22 has determined that automatic driving vehicle 6 can continue with the traveling (YES at S16), the process returns to step S13. In this manner, traveling determiner 22 obtains a plurality of traveling tasks until automatic driving vehicle 6 arrives at the destination and thus allows automatic driving vehicle 6 to travel.

Next, a detailed process of determination device 5 of information processing system 1 will be described.

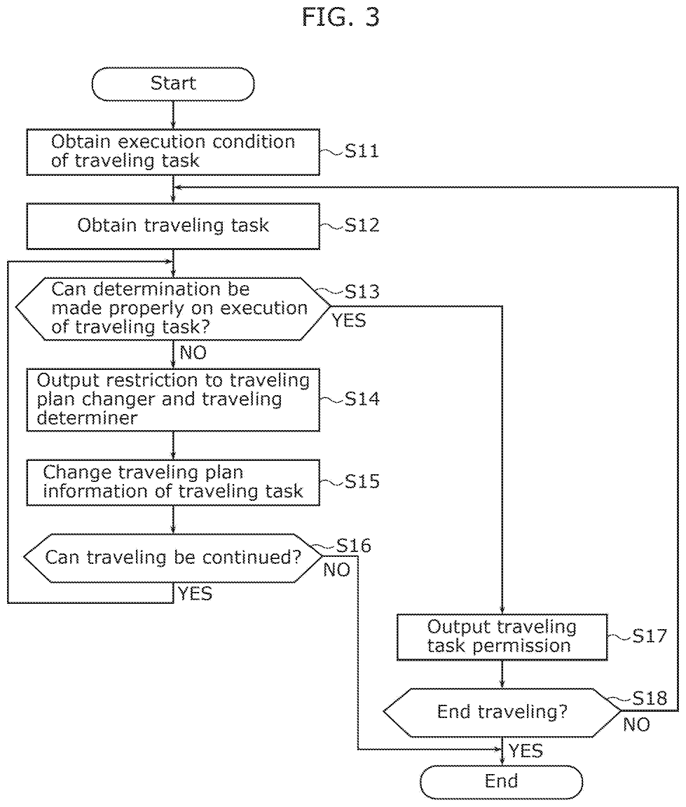

FIG. 4A is a flowchart illustrating a detailed process of determination device 5 according to the embodiment. In FIG. 4A, the assumption is that the process is executed after automatic driving vehicle 6 has started traveling.

Prior to the start of the process, condition obtainer 55 calculates and obtains the required sensing region. Specifically, condition obtainer 55 calculates and obtains the required sensing region based on the vehicle specification information and the traveling task obtained via determiner 56. The details of the process of calculating the required sensing region will be described later.

As illustrated in FIG. 4A, upon obtaining a traveling task from operation controlling device 3, traveling task obtainer 51 outputs the obtained traveling task to determiner 56. Thus, determiner 56 obtains the traveling task (S21).

Next, determiner 56 obtains the first sensing data from automatic driving device 2 (S22).

Next, determiner 56 obtains the second sensing data from infrastructure device 4 (S23).

Next, determiner 56 calculates and obtains the actual sensing region based on the first sensing data and the second sensing data (S24). As illustrated in FIG. 4B, the actual sensing region includes the sensing device name and the actual sensing range for each target region. The actual sensing range is indicated by the entire region or the actual sensing distance. For example, in FIG. 4B, the actual sensing range of target region A0 is the entire region, and the actual sensing range of each of target regions A1 to A8 is indicated by the numerical value of the actual sensing distance. FIG. 4B illustrates an example of an actual sensing region of information processing system 1 according to the embodiment. The actual sensing region is a region defined based on the first sensing region and the second sensing region. For example, the actual sensing region is a region in which the first sensing region and the second sensing region are combined (in other words, a combined sensing region). The actual sensing distance is the distance by which first sensing block 21 (i.e., automatic driving vehicle 6) or second sensing block 41 (i.e., infrastructure device 4) has actually performed sensing.

Referring back to FIG. 4A, next, determiner 56 determines whether the combined sensing region is sufficient (S25). Specifically, determiner 56 determines whether to restrict the execution of the traveling task based on the first sensing region or the second sensing region and the required sensing region.

If determiner 56 has determined that the combined sensing region is sufficient (YES at S25), determiner 56 outputs a traveling task permission to traveling determiner 22 (S31).

Next, determination device 5 determines whether automatic driving vehicle 6 has ended the traveling (S32). Specifically, determination device 5 determines whether traveling determiner 22 has ended the traveling of automatic driving vehicle 6.

If determination device 5 has determined that automatic driving vehicle 6 has ended the traveling (YES at S32), the process is terminated. Meanwhile, if determination device 5 has determined that automatic driving vehicle 6 has not ended the traveling (NO at S32), the process returns to step S21.

If determiner 56 has determined that the combined sensing region is not sufficient (NO at S25), determiner 56 determines whether the issue can be resolved by adjusting infrastructure device 4 (i.e., second sensing block 41) (S26). Specifically, determiner 56 determines whether the combined sensing region can be made sufficient by, for example but not limited to, adjusting the installation position of infrastructure device 4, the sensing region of second sensing block 41, or the precision of second sensing block 41. In this example, the stated issue may be resolved instead by adding another sensor or modifying the infrastructure, for example. In addition, as for how to resolve the issue, the items that can be adjusted may be set in advance, and the manager may be notified of the selected method of resolving the issue.

Next, if determiner 56 has determined that the issue can be resolved by adjusting infrastructure device 4 (YES at S26), determiner 56 adjusts infrastructure device 4 (S33), and the process then returns to step S23. In this example, the processes at step S26 and step S33 are not essential and may thus be omitted.

Meanwhile, if determiner 56 has determined that the issue cannot be resolved even if infrastructure device 4 is adjusted (NO at S26), traveling task restrictor 57 restricts the execution of the traveling task by generating a restriction for the traveling task for which the combined sensing region has been determined to be not sufficient (S27).

Traveling task restrictor 57 outputs the generated restriction to traveling plan changer 33 and thus causes traveling plan changer 33 to make a change to the traveling plan information (including the obtained traveling task) (S28). Based on the restriction, traveling plan changer 33 makes a change to the traveling plan information stored in first storage 32.

Next, traveling task restrictor 57 determines whether automatic driving vehicle 6 can continue with the traveling based on the changed traveling plan information (S29). Traveling task restrictor 57 obtains the result of the determination that traveling determiner 22 has made as to whether automatic driving vehicle 6 can continue with the traveling that is based on the traveling task that has been changed along with the traveling plan information.

If traveling task restrictor 57 has determined that automatic driving vehicle 6 cannot continue with the traveling (NO at S29), traveling task restrictor 57 outputs an instruction to traveling determiner 22 to end the traveling of automatic driving vehicle 6 (S30). Automatic driving vehicle 6 ends the traveling. Then, determination device 5 terminates the process.

If traveling task restrictor 57 has determined that automatic driving vehicle 6 can continue with the traveling (YES at S29), the process returns to step S25.

Now, the process for calculating the required sensing region will be described.

To calculate the required sensing region, first, the calculation of the required sensing distance will be described. The required sensing distance is a predetermined distance from an intersection region to be held when, for example, automatic driving vehicle 6 enters the intersection. This predetermined distance is the distance for performing sensing of any mobile body entering the intersection.

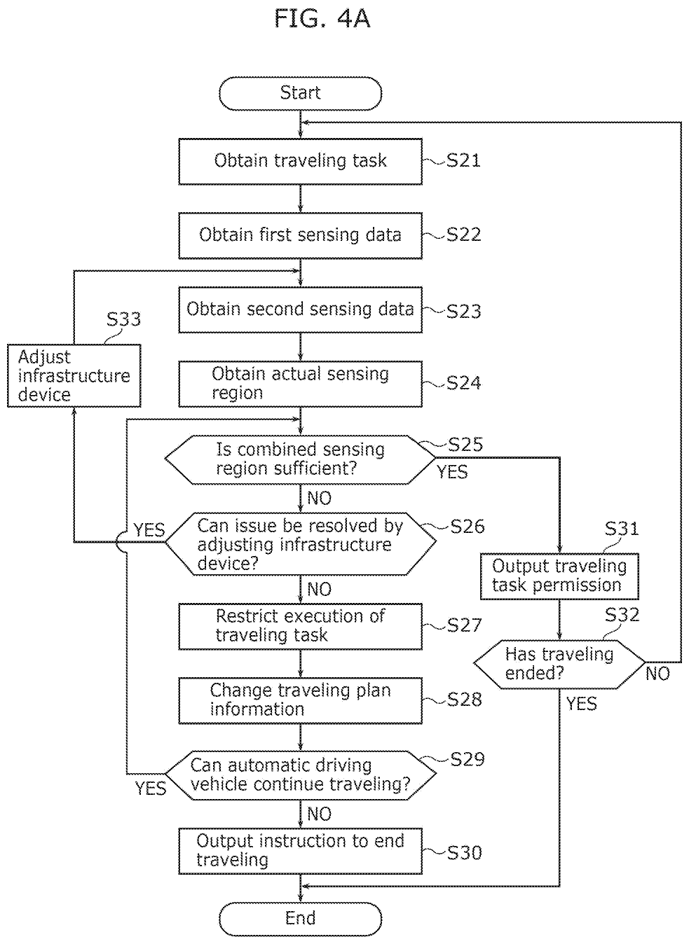

FIG. 5 is a flowchart illustrating a process of calculating the required sensing distance.

As illustrated in FIG. 5, condition obtainer 55 obtains the safety requirement information from fourth storage 54 (S41). For example, in a case where that no other mobile body enters the intersection is set as the traveling environment requirement of the safety requirement information, automatic driving vehicle 6 can safely enter the intersection. In addition, in a case where that the sensing can be performed on other mobile bodies inside and the surroundings of the intersection is set as the sensing requirement of the safety requirement information, the possibility that automatic driving vehicle 6 fails to see other mobile bodies can be reduced, that is, an occurrence of an accident or an incident can be reduced.

Next, condition obtainer 55 obtains the traveling site information from third storage 53. Condition obtainer 55 searches a target region for sensing from the obtained traveling site information (S42). Specifically, condition obtainer 55 determines, based on the traveling site information, the lane of the road and the region as the target region that should be subjected to sensing for each traveling task.

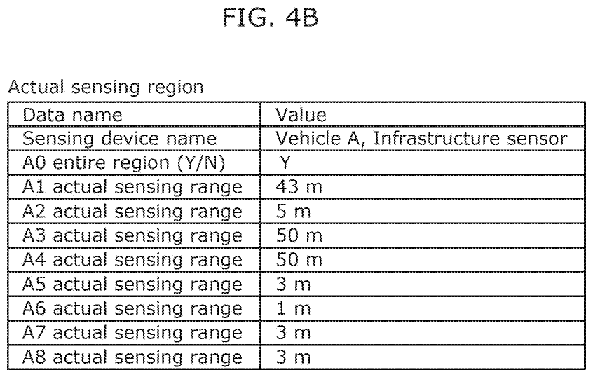

For example, as illustrated in FIG. 6, in a case where automatic driving vehicle 6 enters intersection region A0 with no traffic signal from lane A5, the lanes via which another mobile body can enter intersection region A0 are lanes A1, A3, and A7, as indicated by the vertical hatching. Condition obtainer 55 refers to the target region type specified by the safety requirement information and searches the region corresponding to the target region type. In FIG. 6, intersection region A0 and lanes A1, A3, and A7 correspond to the target regions, and thus they are each determined to be the target region. A portion of a target region lane serves as required sensing region R1. This will be elaborated later. FIG. 6 illustrates an example of required sensing region R1 and a required sensing distance.

Next, condition obtainer 55 calculates the required sensing distance (S43). Specifically, condition obtainer 55 calculates the required sensing distance for each traveling task based on the required sensing distance calculating input (the maximum speed of automatic driving vehicle 6, the speed limit, the speed at which automatic driving vehicle 6 enters the intersection, the maximum acceleration, the vehicle response time, the right turn path length, the assumed maximum speed of other vehicles, and so on).

To be more specific, condition obtainer 55 calculates time tₘₐₓ velocity required for automatic driving vehicle 6 to accelerate to the maximum speed by plugging maximum speed vₘₐₓ of automatic driving vehicle 6, speed vₘᵢₙ at which automatic driving vehicle 6 enters the intersection, and maximum acceleration aₘₐₓ into Expression (1). For example, when automatic driving vehicle 6 is to start traveling, vₘᵢₙ is set to 0.

$$\begin{matrix}[ Math . 1 ] & \\ {t}_{max velocity} = ( {v}_{max} - {v}_{min} ) / {a}_{max} & ( Expression 1 )\end{matrix}$$

Moreover, condition obtainer 55 calculates distance Iₘₐₓ required for automatic driving vehicle 6 to accelerate to the maximum speed by plugging maximum speed vₘₐₓ of automatic driving vehicle 6, speed vₘᵢₙ at which automatic driving vehicle 6 enters the intersection, and time t_{max velocity} into Expression (2).

$$\begin{matrix}[ Math . 2 ] & \\ {l}_{max velocity} = \frac{1}{2} ( {v}_{max} \times {t}_{max velocity} ) + {v}_{min} \times {t}_{max velocity} & ( Expression 2 )\end{matrix}$$

Moreover, condition obtainer 55 calculates time tₜₐₛₖ it takes for automatic driving vehicle 6 to complete the traveling task by plugging maximum speed vₘₐₓ of automatic driving vehicle 6, maximum acceleration aₘₐₓ, vehicle response time tᵣₑₛₚₒₙₛₑ, right turn path length Iₜₐₛₖ, time t_{max velocity}, and distance Iₘₐₓ velocity into Expression (3).

$$[ Math . 2 ]$$

$$( Expression 3 )$$

$${t}_{task} = \{ \begin{matrix}\sqrt{2 {l}_{task} / {a}_{max}} + {t}_{response} & ( {l}_{max velocity} > {l}_{task} ) \\ {t}_{max velocity} + \frac{{l}_{task} - {l}_{max velocity}}{{v}_{max}} + {t}_{response} & ( otherwise )\end{matrix}$$

Moreover, condition obtainer 55 calculates maximum distance I_{move other vehicle} that another mobile body travels by the time automatic driving vehicle 6 completes the traveling task by plugging time tₜₐₛₖ and assumed maximum speed of other vehicles vₒₜₕₑᵣ into Expression (4).

$$\begin{matrix}[ Math . 4 ] & \\ {l}_{move other vehicle} = {v}_{other} \times {t}_{task} & ( Expression 4 )\end{matrix}$$

Condition obtainer 55 sets calculated distance I_{move other vehicle} as the required sensing distance.

In this manner, the required sensing distance can be calculated in information processing system 1. For example, in FIG. 6, in a case where automatic driving vehicle 6 makes a right turn at intersection region A0, the required sensing distance from intersection region A0 is calculated for each of lanes A1, A3, and A7. With this operation, detection of no other mobile body entering the intersection until automatic driving vehicle 6 completes the right turn can be set in the sensing requirement (in other words, the safety requirement).

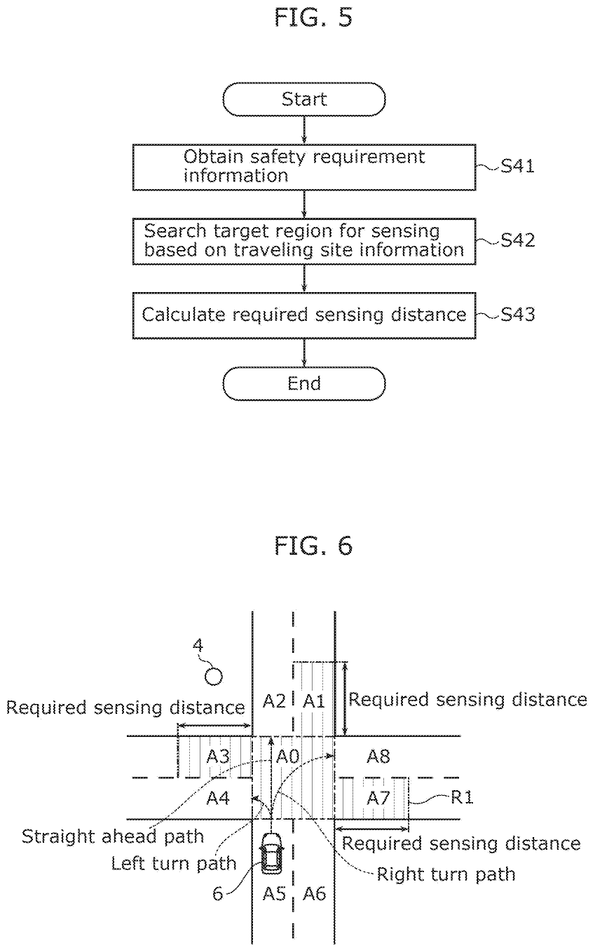

Now, a process of searching a target region lane in the search of the target region performed at step S42 of FIG. 5 will be described with reference to FIG. 7.

FIG. 7 is a flowchart illustrating a process of searching a target region lane.

As illustrated in FIG. 6 and FIG. 7, condition obtainer 55 determines, among approach lanes A1, A3, A5, and A7 from which a mobile body can enter intersection region A0 that automatic driving vehicle 6 is to enter, lanes A1, A3, and A7 as the lanes from which a mobile body other than automatic driving vehicle 6 may enter intersection region A0 (S51).

Next, condition obtainer 55 determines whether there is a traffic signal in intersection region A0 (S52).

If there is no traffic signal in intersection region A0 (NO at S52), condition obtainer 55 determines all approach lanes A1, A3, and A7 other than lane A5 where automatic driving vehicle 6 is located as the target region lanes (S53).

If there is a traffic signal in intersection region A0 (YES at S52), condition obtainer 55 determines approach lane A1 of the vehicle oncoming to automatic driving vehicle 6 as the target region lane (S54).

Now, the calculation of an actual sensing region of information processing system 1 will be described.

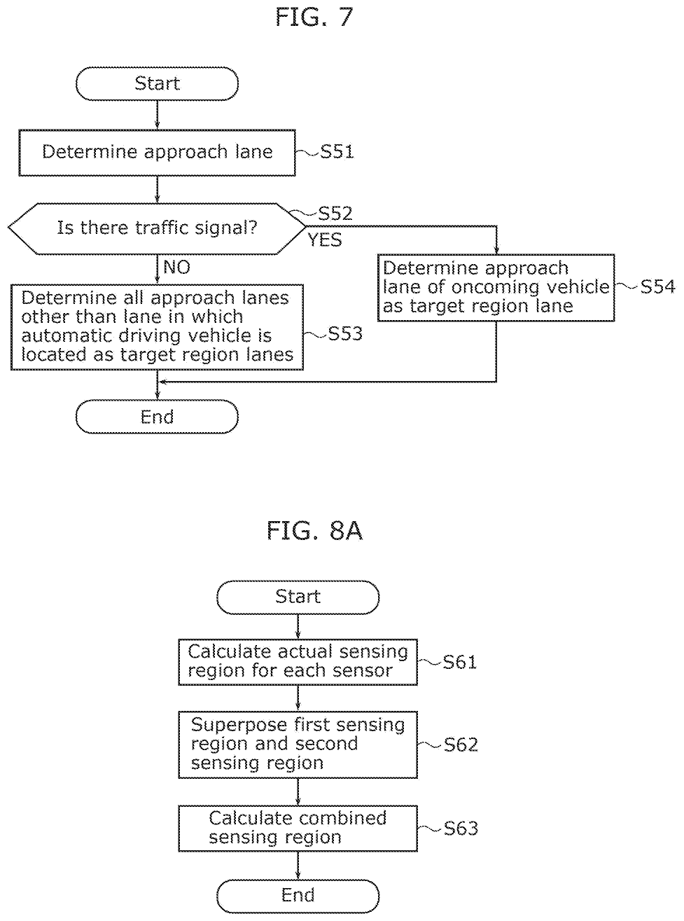

FIG. 8A is a flowchart illustrating a process of calculating an actual sensing region.

First, as illustrated in FIG. 8A, determiner 56 calculates the actual sensing region for each sensor (first sensing block 21 and second sensing block 41) (S61). This calculation of the actual sensing region for each sensor will be described with reference to FIG. 8B. FIG. 8B is a flowchart illustrating a process of calculating the actual sensing region for each sensor.

In the following section, an example in which the sensor is first sensing block 21 will be described. As illustrated in FIG. 8B, determiner 56 obtains a maximum sensing distance of first sensing block 21 (S61a). For example, determiner 56 obtains the maximum sensing distance of first sensing block 21 based on the vehicle specification information stored in second storage 52.

Next, determiner 56 calculates the distance from first sensing block 21 (i.e., automatic driving vehicle 6) to an object in each direction based on the first sensing data (S61b).

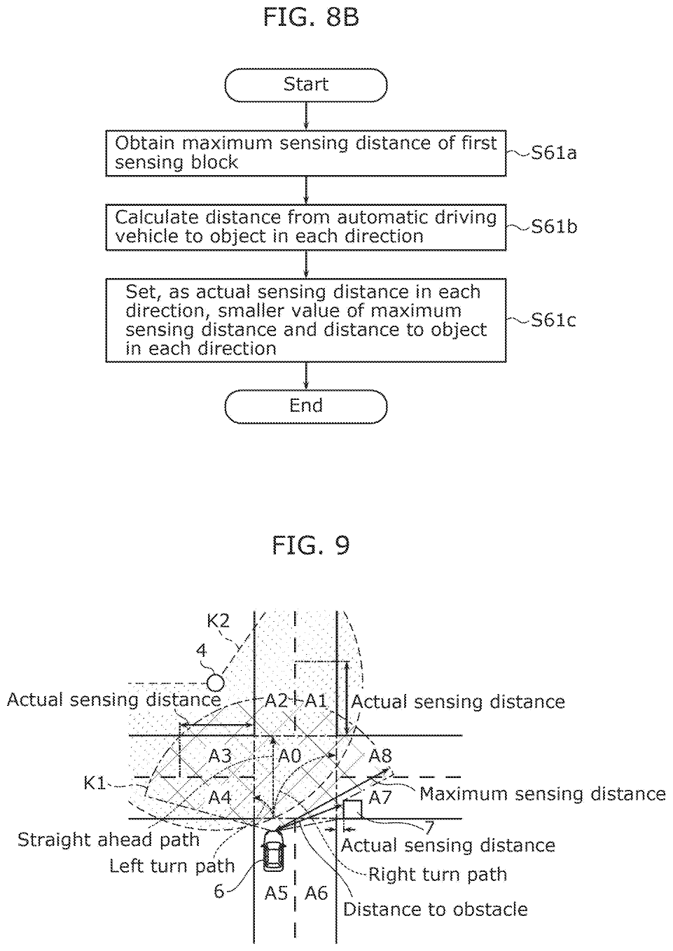

Of the maximum sensing distance and the distance to an object in each direction, determiner 56 sets a smaller distance as the actual sensing distance in each direction (S61c). For example, in FIG. 9, the distance from automatic driving vehicle 6 in lane A5 to obstacle 7 is smaller than the maximum sensing distance. Therefore, determiner 56 sets the distance from automatic driving vehicle 6 to obstacle 7 as the actual sensing distance. The side opposite automatic driving vehicle 6 across obstacle 7 is the blind zone of automatic driving vehicle 6. FIG. 9 illustrates an example of a relationship between first sensing region K1 and second sensing region K2.

The description now returns to step S62 of the flowchart illustrated in FIG. 8A.

Next, determiner 56 superposes the first sensing region, which is the actual sensing region, on the second sensing region (S62). In FIG. 9, first sensing region K1 is indicated by diagonal lattice pattern hatching, and second sensing region K2 is indicated by dot pattern hatching.

Next, based on the result of superposing first sensing region K1 and second sensing region K2 on each other, determiner 56 calculates the actual sensing region, that is, the combined sensing region to be used in the process of determining whether to restrict the traveling task (S63).

Specifically, determiner 56 determines, as the combined sensing region, a region that is covered by either one of the first sensing region and the second sensing region. In other words, the sum of the first sensing region and the second sensing region is determined as the combined sensing region. For example, the portion with the diagonal lattice pattern hatching or with the dot pattern hatching in FIG. 9 is determined as the combined sensing region.

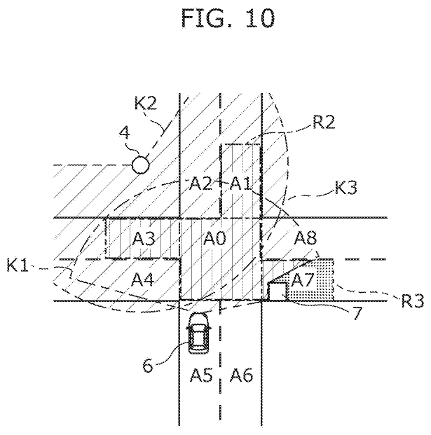

In this manner, the process of determining whether to restrict the execution of the traveling task (step S25 of FIG. 4A) is performed based on the required sensing region calculated through the process illustrated in FIG. 5 and FIG. 7 and the actual sensing region calculated through the process illustrated in FIG. 8A and FIG. 8B. With reference to FIG. 10, an example of the above-described determination process that is based on the required sensing region and the actual sensing region will be described. FIG. 10 illustrates an example of a relationship between a required sensing region and an actual sensing region.

In FIG. 10, the sum of first sensing region K1 and second sensing region K2 is indicated as actual sensing region K3 with diagonal hatching. In addition, of the required sensing region, region R2 that overlaps actual sensing region K3 is indicated by vertical hatching, and region R3 that does not overlap actual sensing region K3 is indicated by hatching of densely arranged dots. Since partial region R3 of the actual sensing region does not overlap actual sensing region K3, determiner 56 determines to restrict the execution of the traveling task, that is, the execution of a right turn.

### [Workings and Advantageous Effects]

Next, some workings and advantageous effects of the information processing method and information processing system 1 according to the present embodiment will be described.

As described above, with the information processing method and information processing system 1 according to the present embodiment, when a mobile body travels, the execution of a traveling task can be restricted depending on the traveling specification of the mobile body. In other words, the execution of the traveling task can be restricted when the traveling specification and the sensor specification are not appropriate for the traveling situation. Accordingly, this configuration allows mobile bodies of various specifications to safely execute traveling tasks.

For example, as will be described later, in a case where the traveling specification and the sensor specification of a mobile body are not appropriate for a given traveling situation and the execution of the traveling task cannot be completed or the traveling task cannot be executed, that is, in a case where the mobile body cannot travel, the execution of this traveling task is stopped. This makes it possible to suppress an occurrence or an accident or an incident associated with the execution of this traveling task. Moreover, for example, in a case where the traveling specification and the sensor specification of a mobile body are not appropriate for a given traveling situation and the traveling task cannot be executed safely, that is, in a case where the mobile body cannot travel safely, the content of the execution of this traveling task is changed. With this configuration, even if the mobile body does not completely satisfy the safety condition for the traveling, the mobile body can continue to travel safely by executing a traveling task whose content has been restricted, in place of the original traveling task.

### [Variation 1]

The information processing method and information processing system 1 have been described as an example according to the foregoing embodiment, but this is not a limiting example. Terminal device 80 and monitorer terminal 90 may be connected to and be capable of communicating with information processing system 1. In the following section, this case will be described as Variation 1 with the description centered on the differences from the foregoing embodiment.

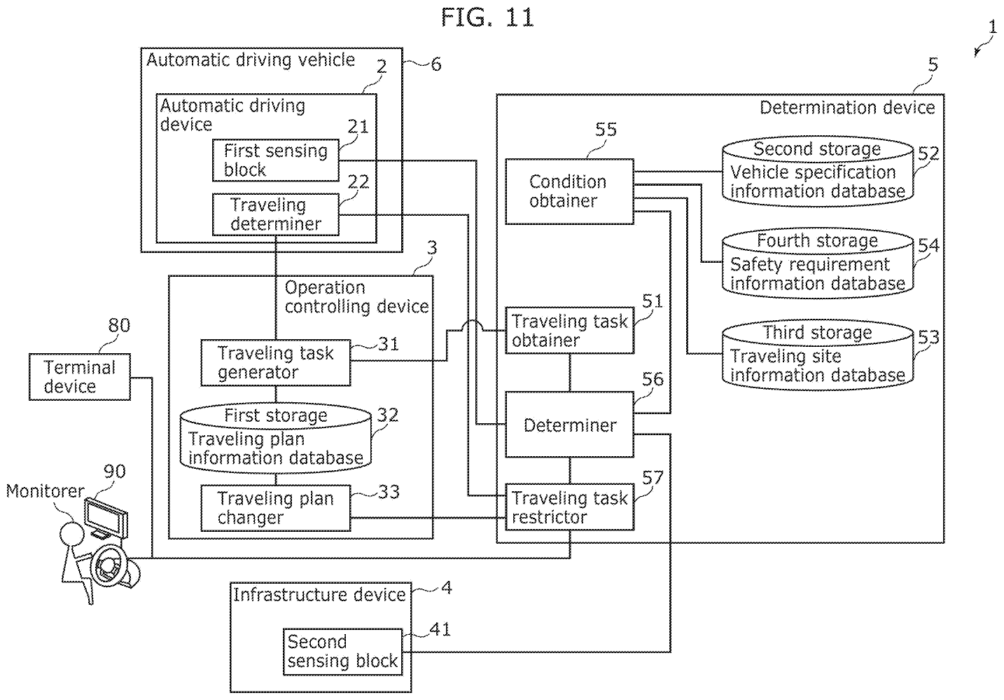

FIG. 11 is a schematic diagram illustrating information processing system 1 according to Variation 1.

### [Traveling Task Restrictor 57]

As illustrated in FIG. 11, traveling task restrictor 57 determines a monitoring mode with which a monitorer monitors automatic driving vehicle 6 in accordance with the result of a determination as to whether to restrict the execution of a traveling task. Specifically, in a case where determiner 56 has determined to restrict the execution of a traveling task, traveling task restrictor 57 adds automatic driving vehicle 6 to the targets to be monitored or raises the monitoring priority of automatic driving vehicle 6.

Moreover, traveling task restrictor 57 outputs information indicating that the execution of the traveling task has been restricted to terminal device 80 and monitorer terminal 90, which will be described later. With this configuration, the manager or an occupant of automatic driving vehicle 6 is notified that the execution of the traveling task has been restricted. In this example, traveling task restrictor 57 may output, to terminal device 80 and monitorer terminal 90, information indicating that automatic driving vehicle 6 is to be added to the targets to be monitored or that the monitoring priority of automatic driving vehicle 6 is to be raised.

### [Terminal Device 80]

Terminal device 80 is, for example but not limited to, a car navigation device, a personal computer, a smartphone, or a tablet terminal that is connected to and is capable of communicating with information processing system 1. Terminal device 80 notifies the owner or an occupant of automatic driving vehicle 6 of at least one of automatic driving vehicle 6 that has been added to the targets to be monitored, automatic driving vehicle 6 whose monitoring priority has been raised, automatic driving vehicle 6 of which the execution of a traveling task is to be restricted, or information indicating that the execution of a traveling task is to be restricted. Such notification may be implemented, for example but not limited to, through display by a display device, such as a display, or through an audible output from an acoustic device, such as a loudspeaker. The owner is an example of the manager.

### [Monitorer Terminal 90]

Monitorer terminal 90 is, for example but not limited to, a personal computer, a smartphone, or a tablet terminal that is connected to and is capable of communicating with information processing system 1. Monitorer terminal 90 obtains, from traveling task restrictor 57, at least one of automatic driving vehicle 6 that has been added to the targets to be monitored, automatic driving vehicle 6 whose monitoring priority has been raised, automatic driving vehicle 6 of which the execution of a traveling task is to be restricted, or information indicating that the execution of a traveling task has been restricted. Then, monitorer terminal 90 provides notification to the monitorer accordingly. Such notification may be implemented, for example but not limited to, through display by a display device, such as a display, or through an audible output from an acoustic device, such as a loudspeaker. The monitorer is an example of the manager.

With the information processing method described above, an occurrence of an accident or an incident can be reduced. Even if an accident or an incident occurs, the monitorer can respond to the accident or the incident promptly. Moreover, the manager or an occupant can find that the execution of the traveling task of the mobile body has been restricted. In addition, since it suffices that this mobile body be monitored preferentially, the burden on the monitorer monitoring mobile bodies can be reduced. Furthermore, any discomfort that an occupant feels about the mobile body that the occupant is riding can be reduced.

### [Variation 2]

In the example described above according to the foregoing embodiment, the sensing requirement is the required sensing region. Alternatively, the sensing requirement may be another requirement. Specifically, the sensing requirement is a required sensing target that requires sensing, the first sensing result is a first sensing target calculated based on the first sensing data, and determiner 56 determines whether to restrict the execution of a traveling task based on the required sensing target and the first sensing target. The second sensing result is a second sensing target in a similar manner, and the second sensing target may be used in the determination described above.

To be more specific, determiner 56 determines whether to restrict the execution of a traveling task based on the degree of sufficiency of the required sensing target and the first sensing target (i.e., whether the first sensing target includes the required sensing target). For example, the required sensing target is a geographical stationary object, such as a traffic signal, a road sign, a curbstone, or a road surface sign, or the number of such geographical stationary objects. In addition, the required sensing target is a geographical situation, such as an intersection, a curve, or a bridge crossing. Information on the items that can serve as a required sensing target is added to the traveling site information and the safety requirement information.

An example of the process will be described below.

First, condition obtainer 55 calculates the required sensing target as the execution condition of the traveling task based on the traveling task, the vehicle specification information, the traveling site information, and the safety requirement information. For example, for the traveling task of making a right turn at site C, condition obtainer 55 obtains the arrangement of a geographical stationary object at site C and the geographical situation of site C from the traveling site information and obtains the speed and the acceleration from the vehicle specification. Condition obtainer 55 calculates, based on the obtained information, the geographical stationary object or the geographical situation required of sensing specified by the safety requirement information. For example, a traffic signal and a signboard present at the intersection in the traveling direction of automatic driving vehicle 6 are calculated as the required sensing target at a position preceding the intersection by a predetermined distance or more.

Determiner 56 calculates the first sensing target from the first sensing data and the second sensing target from the second sensing data. For example, determiner 56 calculates, as the first sensing target and the second sensing target, each object (e.g., a signboard) located in the traveling direction of automatic driving vehicle 6 based on the first sensing data and the second sensing data, such as image data or point cloud data.

Determiner 56 determines whether to restrict the execution of the traveling task based on the required sensing target, the first sensing target, and the second sensing target. For example, determiner 56 determines whether the object calculated as the first sensing target and the second sensing target is the object calculated as the required sensing target, such as the traffic signal or the signboard described above. If determiner 56 has determined that the object calculated as the first sensing target and the second sensing target fails to include at least one of the traffic signal or the signboard calculated as the required sensing target, determiner 56 determines to restrict the execution of the traveling task. Otherwise, determiner 56 determines not to restrict the execution of the traveling task.

In this example, determiner 56 may determine whether to restrict the execution of the traveling task based on the degree of match between the required sensing target and the first sensing target. For example, in a case where the required sensing target is a traffic signal and a signboard and the first sensing target is a traffic signal and a crosswalk, the execution of the traveling task is restricted since the required sensing target and the first sensing target fail to match each other. In a similar manner, in a case where the first sensing target is a traffic signal, a signboard, and a crosswalk, the execution of the traveling task is restricted since the required sensing target and the first sensing target fail to match each other.

Moreover, determiner 56 may determine whether to restrict the execution of the traveling task based on whether the first sensing target includes the state of the required sensing target (i.e., the degree of match between or the degree of sufficiency of the state of the required sensing target and the state of the first sensing target).

Even if the sensing targets match each other, whether it is safe to execute the traveling task varies depending on the state of each target. Therefore, restricting the execution of the traveling task based on the degree of match between the states of the respective sensing targets allows the mobile body to execute the traveling task more safely. For example, the execution of the traveling task can be restricted if the state of the required sensing target and the state of the target sensed by the mobile body differ from each other.

### [Variation 3]

As in Variation 2 described above, the sensing requirement may be another requirement. Specifically, the sensing requirement is required sensing performance that is to be subjected to sensing, the first sensing result is first sensing performance calculated based on the first sensing data, and determiner 56 determines whether to restrict the execution of a traveling task based on the required sensing performance and the first sensing performance. The second sensing result is second sensing performance in a similar manner, and the second sensing performance may be used in the determination described above.

To be more specific, determiner 56 determines whether to restrict the execution of a traveling task based on whether the first sensing performance is higher than the required sensing performance. For example, the required sensing performance is, for example but not limited to, the precision of the sensing, the accuracy of the sensing, the resolution, or the processing cycle. Information on the items that can serve as required sensing performance is added to the safety requirement information.

An example of the process will be described below.

First, condition obtainer 55 calculates the required sensing performance as the execution condition of the traveling task based on the traveling task, the vehicle specification information, the traveling site information, and the safety requirement information. For example, for the traveling task of making a right turn at site C, condition obtainer 55 obtains the speed limit and the assumed maximum speed of other vehicles from the traveling site information and obtains the speed and the acceleration from the vehicle specification. Condition obtainer 55 calculates, based on the obtained information, the precision of the sensing specified by the safety requirement information. For example, the processing cycle that can ensure the time sufficient to avoid another vehicle trying to enter the intersection is calculated as the required sensing performance.

Determiner 56 calculates the first sensing performance from the first sensing data and the second sensing performance from the second sensing data. For example, determiner 56 calculates, as the first sensing performance and the second sensing performance, the processing cycle of each of first sensing block 21 and second sensing block 41 based on, respectively, the first sensing data and the second sensing data, such as image data or point cloud data.

Determiner 56 determines whether to restrict the execution of the traveling task based on the required sensing performance, the first sensing performance, and the second sensing performance. For example, determiner 56 determines whether the processing cycle calculated as the first sensing performance and the second sensing performance is shorter than the processing cycle calculated as the required sensing performance. If determiner 56 has determined that either of the processing cycle calculated as the first sensing performance and the processing cycle calculated as the second sensing performance is no shorter than the processing cycle calculated as the required sensing performance, determiner 56 determines to restrict the execution of the traveling task. Otherwise, determiner 56 determines not to restrict the execution of the traveling task.

### [Variation 4]

Determiner 56 calculates the first sensing result and the second sensing result according to the foregoing embodiment, but this is not a limiting example. The first sensing result and the second sensing result may be calculated by first sensing block 21 and second sensing block 41, respectively. In this case, the first sensing result and the second sensing result are output to determination device 5, that is, determiner 56.

### [Variation 5]

The mobile body is an automatic driving vehicle according the foregoing embodiment, but this is not a limiting example. The mobile body may be an autonomous mobile robot. For example, a robot that moves along a corridor used in a building is assumed. The mobile body may also be a robot that moves along a road used outside a building. In the example described below, the mobile body is autonomous mobile robot 8. In this example, descriptions of configurations and processes that are substantially identical to the configurations and the processes according to the foregoing embodiment will be omitted.

### [Operation Controlling Device 3]

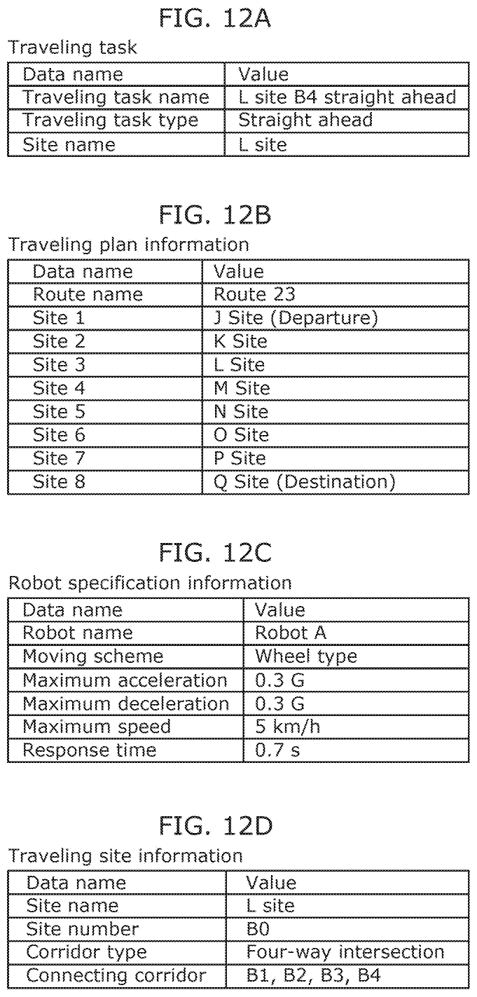

Traveling task generator 31 generates a traveling task based on the traveling plan information of autonomous mobile robot 8 obtained from first storage 32. For example, as illustrated in FIG. 12A, a traveling task includes the traveling task name, the traveling task type, and the site name. FIG. 12A illustrates an example of a traveling task of information processing system 1 according to Variation 5.

As illustrated in FIG. 12B, traveling plan information includes the route and the site or sites where the traveling task is executed along the route. The site includes a site inside a building where an elevator or the like is installed, in addition to the departure site, the destination, a right turn site, a left turn site, or a stopping site. FIG. 12B illustrates an example of traveling plan information of information processing system 1 according to Variation 5.

First storage 32 stores a traveling plan information database indicating a traveling plan of autonomous mobile robot 8.

### [Determination Device 5]

Second storage 52 stores a database of robot specification information indicating the specification of autonomous mobile robot 8 (hereinafter, a robot specification information database). Second storage 52 outputs robot specification information in response to a request from condition obtainer 55. The robot specification is a specification related to the traveling of autonomous mobile robot 8. Specifically, as illustrated in FIG. 12C, the robot specification information includes, for example but not limited to, the robot name, the moving scheme, the maximum acceleration, the maximum deceleration, the maximum speed, and the response time. FIG. 12C illustrates an example of robot specification information of information processing system 1 according to Variation 5.

Third storage 53 stores a traveling site information database. As illustrated in FIG. 12D, the traveling site information includes map information, such as the site name, the site number assigned to the site name, or the corridor type, as well as traffic environmental information, such as an approach lane. In this example, the traffic environmental information may include information indicating the presence or absence of equipment inside the building or the type of the equipment. FIG. 12D illustrates an example of traveling site information of information processing system 1 according to Variation 5.

Fourth storage 54 stores a safety requirement information database. As illustrated in FIG. 12E, the safety requirement information includes, for example but not limited to, the traveling task name, the target region type, the corridor type, the required sensing range within the site, the required sensing range of a connecting corridor, and the required sensing range calculating input. Among the above, the target region type, the required sensing range within the site, and the required sensing range of a connecting corridor are the safety requirements related to the sensing requirements. FIG. 12E illustrates an example of safety requirement information of information processing system 1 according to Variation 5.

The target region type indicates the type of a region where there is a possibility that autonomous mobile robot 8 collides with another object. Specifically, in the example illustrated in FIG. 12E, the target region type indicates that the inside of the site and the corridors connecting to the site are indicated as the type of the region described above.

The required sensing range within the site is the required sensing range of the region whose type is the inside of the site. For example, since there is a possibility that autonomous mobile robot 8 collides with another mobile body at any portion inside the site, the required sensing range of the inside of the site is set to the entire region in the example illustrated in FIG. 12E.

The required sensing range of a connecting corridor is the required sensing range of the region whose type is the connecting corridor. For example, since the possibility of a collision is low in a region far away from the connection to the site, the required sensing range of a connecting corridor is set to the region spanning from the connection to the required sensing distance in the example illustrated in FIG. 12E.

The required sensing range calculating input is information that is input to calculate the required sensing distance described above. In the example illustrated in FIG. 12E, the required sensing range calculating input is, for example but not limited to, the maximum speed, the maximum acceleration, and the response time of autonomous mobile robot 8.

Condition obtainer 55 obtains the robot specification information from second storage 52 and the traveling site information from third storage 53. Moreover, condition obtainer 55 obtains a traveling task from traveling task obtainer 51 via determiner 56. Moreover, condition obtainer 55 obtains the safety requirement information from fourth storage 54.

Condition obtainer 55 calculates the execution condition of the traveling task. The execution condition of the traveling task is the execution condition of the traveling task corresponding to at least one of autonomous mobile robot 8 or the traveling site. Specifically, condition obtainer 55 calculates the sensing requirement based on the robot specification information, the traveling task, and the safety requirement information. Specifically, condition obtainer 55 calculates the required sensing region based on the robot specification information, the traveling task, and the safety requirement information.

The required sensing region includes the robot name, the traveling task name, the target region ID, and the required sensing range for each region type. The required sensing range is, for example, the entire region or the required sensing distance in the target region. In the example illustrated in FIG. 12F, the entire region is set for target region B0, and the required sensing distance of 3 meters is set for each of target regions B1, B2, and B3. FIG. 12F illustrates an example of a required sensing region of information processing system 1 according to Variation 5.

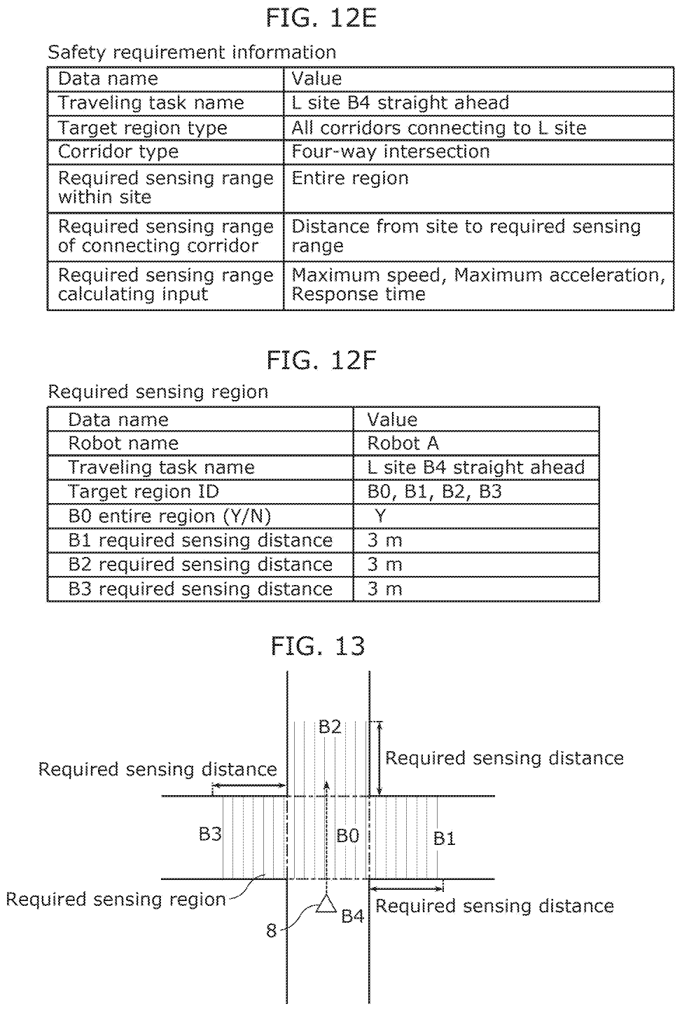

Next, with reference to FIG. 13, the calculation of the sensing requirement will be described. Condition obtainer 55 searches a target region for sensing based on the robot specification information, the traveling task, and the safety requirement information. Specifically, condition obtainer 55 determines a region and a corridor connecting to the region as the target region for sensing for each traveling task based on the traveling site information identified from the safety requirement information.

For example, as illustrated in FIG. 13, in a case where autonomous mobile robot 8 enters intersection region B0 from connecting corridor B4, the corridors connecting to intersection region B0 are corridors B1, B2, and B3, as indicated by vertical hatching. Condition obtainer 55 refers to the target region type specified by the safety requirement information and searches the region type corresponding to the target region type. In the example illustrated in FIG. 13, intersection region B0 and corridors B1, B2, and B3 correspond to the target regions, and thus they are each determined to be the target region. A portion of the corridor serving as a target region serves as required sensing region R1. FIG. 13 illustrates an example of required sensing region R1 and a required sensing distance.

Determiner 56 obtains the first sensing data from first sensing block 21, the second sensing data from second sensing block 41, and the execution condition including the sensing requirement from condition obtainer 55. Moreover, determiner 56 obtains the traveling task from traveling task obtainer 51. For the processes of determiner 56 and traveling task restrictor 57, the description of the foregoing embodiment should be referred to.

In this manner, even when the mobile body is an autonomous mobile robot, the configuration according to the embodiment of the present disclosure can be applied.

### (Others)

Thus far, the present disclosure has been described based on the embodiment and the variations, but the present disclosure is not limited to this embodiment and the variations.

For example, the information processing method and the information processing system according to the foregoing embodiment and variations may be implemented by a computer program, and such a program may be stored in a storage device.

Moreover, the information processing method and and each processor included in the information processing system according to the foregoing embodiment and variations are typically implemented in the form of a large scale integration (LSI), which is an integrated circuit. The processors may each be implemented by a single chip, or part or the whole of the processors may be implemented by a single chip.

The circuit integration is not limited to the LSI, and an integrated circuit may be implemented by a dedicated circuit or a general purpose processor. A field programmable gate array (FPGA) that can be programmed after the LSI has been manufactured or a reconfigurable processor in which the connections or the settings of the circuit cells within the LSI can be reconfigured may also be used.

In the foregoing embodiment and variations, the constituent elements may each be implemented by dedicated hardware or may each be implemented through the execution of a software program suitable for the corresponding constituent element. The constituent elements may each be implemented as a program executing unit, such as a central processing unit (CPU) or a processor, reads out a software program recorded in a recording medium, such as a hard disk or a semiconductor memory, and executes the software program.

All the numbers used in the foregoing are for illustrating examples for describing the present disclosure in concrete terms, and the embodiment and the variations of the present disclosure are not limited to the illustrated numbers.

The divisions of the functional blocks in the block diagrams are merely examples. A plurality of functional blocks may be implemented as a single functional block, a single functional block may be divided into a plurality of functional blocks, or some of the functions may be transferred to another functional block. The functions of a plurality of functional blocks having similar functions may be processed in parallel or through time sharing by a single piece of hardware or software.

The order of executing the steps in each flowchart is for illustrating an example for describing the present disclosure in concrete terms, and the order may differ from the ones described above. Some of the steps described above may be executed simultaneously (in parallel) with another step.

Aside from the above, an embodiment obtained by making various modifications that a person skilled in the art can conceive of to the foregoing embodiment and variations or an embodiment achieved by combining, as desired, the constituent elements and the functions according to the foregoing embodiment and variations within the scope that does not depart from the spirit of the present disclosure is also encompassed by the present disclosure.

### INDUSTRIAL APPLICABILITY

The present disclosure can be applied to an automatic driving vehicle, a device that remotely operates an automatic driving vehicle, an autonomous mobile robot, or a system that includes any of the above.

1. An information processing method to be executed by a computer, the information processing method comprising:
obtaining a task related to traveling executed by a mobile body, first sensing data output from a first sensor that is provided in the mobile body and performs sensing of an outside of the mobile body, and a specification related to the traveling of the mobile body;
calculating a sensing requirement based on the task and the specification;
calculating a first sensing result based on the first sensing data output from the first sensor;
determining whether to restrict execution of the task based on the sensing requirement and the first sensing result; and
outputting an instruction for restricting the execution of the task to the mobile body in response to determining that the execution of the task is to be restricted.

2. The information processing method according to claim 1, wherein
the sensing requirement includes a required sensing region, the required sensing region being a region that requires sensing,
the first sensing result includes a first sensing region calculated based on the first sensing data, and
the determining includes determining whether to restrict the execution of the task based on the required sensing region and the first sensing region.

3. The information processing method according to claim 2, wherein
the determining includes determining whether to restrict the execution of the task based on an overlap between the required sensing region and the first sensing region.

4. The information processing method according to claim 3, wherein
the determining includes determining whether to restrict the execution of the task based on a degree of the overlap between the required sensing region and the first sensing region.

5. The information processing method according to claim 3, wherein
the determining includes determining whether to restrict the execution of the task based on a region in which the required sensing region and the first sensing region do not overlap each other.

6. The information processing method according to claim 2, wherein
the restricting prohibits the execution of the task.

7. The information processing method according to claim 2, wherein
the restricting changes content of the task to be executed.

8. The information processing method according to claim 7, wherein
content of a change in the task is determined based on an overlap between the required sensing region and the first sensing region.

9. The information processing method according to claim 1, further comprising:
obtaining second sensing data output from a second sensor provided on a path of travel of the mobile body; and
calculating a second sensing result based on the second sensing data, wherein
the determining includes determining whether to restrict the execution of the task based further on the second sensing result.

10. The information processing method according to claim 1, further comprising:
adding the mobile body to a target to be monitored or raising a monitoring priority of the mobile body in response to determining that the execution of the task is to be restricted.

11. The information processing method according to claim 1, further comprising:
notifying a manager or an occupant of the mobile body that the execution of the task is to be restricted, in response to determining that the execution of the task is to be restricted.

12. The information processing method according to claim 1, wherein
the sensing requirement includes a required sensing target, the required sensing target being a target that requires sensing,
the first sensing result includes a first sensing target calculated based on the first sensing data, and
the determining includes determining whether to restrict the execution of the task based on the required sensing target and the first sensing target.

13. The information processing method according to claim 12, wherein
the determining includes determining whether to restrict the execution of the task based on a degree of sufficiency of or a degree of match between the required sensing target and the first sensing target.

14. The information processing method according to claim 1, wherein
the sensing requirement includes required sensing performance, the required sensing performance being a target that requires sensing,
the first sensing result includes first sensing performance calculated based on the first sensing data, and
the determining includes determining whether to restrict the execution of the task based on the required sensing performance and the first sensing performance.

15. The information processing method according to claim 14, wherein
the determining includes determining whether to restrict the execution of the task based on whether the first sensing performance is higher than the required sensing performance.

16. An information processing system, comprising:
a first obtainer that obtains a task related to traveling executed by a mobile body;
a second obtainer that obtains first sensing data output from a first sensor that is provided in the mobile body and performs sensing of an outside of the mobile body;
a third obtainer that obtains a specification related to the traveling of the mobile body;
a first calculator that calculates a sensing requirement based on the task and the specification;
a second calculator that calculates a first sensing result based on the first sensing data output from the first sensor;
a determiner that determines whether to restrict execution of the task based on the sensing requirement and the first sensing result; and
an outputter that outputs an instruction for restricting the execution of the task to the mobile body when the execution of the task is determined to be restricted.
